(19) United States
(12) Patent Application Publication
(10) Pub. No.: US 2008/0274704 A1
(43) Pub. Date: Nov. 6, 2008

(54) Rf Transceiver and a Method of Operation Therein

(75) Inventors: Yoel Barzilay, Modi'In (IL); Ronen Digmy, Kiryat Ono (IL); Eitan Ohev-Zion, Hod-Ha'Sharon (IL)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/091,087

(22) PCT Filed: Nov. 16, 2006
(86) PCT No.: PCT/US06/60963

§ 371 Date: Apr. 22, 2008

(30) Foreign Application Priority Data
Nov. 22, 2005 (GB) 0523660.9

(51) Int. Cl. H04B 1/38

(52) U.S. Cl. 455/76

(57) ABSTRACT

A RF transceiver and method of operating a transceiver are provided. The transceiver has a frequency synthesizer that generates a stable, operational frequency signal, a reference VCO that provides a reference frequency for use in operation of the synthesizer, a voltage source coupled to the reference VCO that produces a control voltage that controls an output frequency of the reference VCO, and a controller coupled to the voltage source that controls the voltage applied by the voltage source. The controller compares a value of a known frequency of a RF signal received by the transceiver with a value of a current receiver frequency to estimate an error of the current receiver frequency, calculates, using the estimated error, a change needed to the control voltage to change the reference frequency to eliminate the estimated error, and controls the voltage source to apply the calculated change to the control voltage.

### FIELD OF THE INVENTION

The present invention relates to a RF transceiver and a method of operation therein.

### BACKGROUND OF THE INVENTION

RF transceivers include a transmitter portion and a receiver portion. A device known as a frequency synthesizer is used in RF transceivers to produce operational signals of stable frequency used in the transmitter portion and in the receiver portion. In particular, the frequency synthesizer is employed to generate an operational signal employed as a carrier frequency signal in the transmitter portion and as a local oscillator reference signal in the receiver portion. The synthesizer normally includes a VCO (voltage controlled oscillator) connected in a phase locked loop. Such a VCO is referred to herein as a ‘loop VCO’. The phase locked loop, including the loop VCO, provides an appropriate output signal at a precisely defined frequency.

Such synthesizers employ a reference oscillator to provide a reference signal for use in the phase locked loop. Various reference oscillator types are known. For example, the reference oscillator may comprise a crystal oscillator such as a TCXO (temperature compensated crystal oscillator). The reference oscillator may itself be a VCO, herein referred to as a ‘reference VCO’. Thus, the output frequency obtained from the reference VCO is determined by an analog control voltage applied to the reference VCO. The analog control voltage may for example be obtained from a voltage source comprising a D/A (digital to analog) converter which receives an input control signal from a digital controller to set the level of the analog control voltage.

Normally, a limited range of valid values, e.g. from 0.4V to 2.4V, is specified by the supplier of the reference oscillator for the analog control voltage to be applied to the reference VCO of that oscillator. The analog control voltage to be selected is normally set in a factory, e.g. in which a terminal employing the RF transceiver including the synthesizer and its reference oscillator is manufactured. It is usual for a voltage which is mid-way through a pre-determined working range of valid analog control voltages to be selected for the set voltage. For example, for a working range of analog control voltage values of from 0.4V to 2.4V, it is usual for the analog control voltage to be set at 1.4V to provide the desired output reference frequency.

Unfortunately, the physical properties of the reference VCO used in a reference oscillator can gradually change with age and this can cause a drift in the analog control voltage needed. This change in the physical properties is known as ‘aging’. Environmental factors can contribute to aging. These include temperature, humidity, applied electrical load and supply voltage of the transceiver. A frequency drift of 1 part per million per year may typically be expected with aging.

The drift in reference frequency produced by aging can cause a corresponding drift in the output frequency of the operational signal produced by the frequency synthesizer. When the resulting output frequency differs significantly from its correct value, difficulties may be encountered. For example, where the transceiver in which the frequency synthesizer is used is employed in a communication terminal such as a portable radio or mobile telephone or the like, it may not be possible to provide wireless registration of the terminal with a communication network in which the terminal is required to operate. This failure could happen in an emergency situation with very serious consequences.

The conventional way of dealing with the problem of drift due to aging of the reference VCO output frequency is for the terminal including the reference VCO to be recalled and sent to a service depot. In such a depot, the controller employed to control the analog control voltage of the reference VCO is re-set. When the cumulative frequency drift which has taken place over a long period of time, e.g. several years, is so large that the analog control voltage reaches the end of its pre-determined working range of valid values, the reference VCO is normally discarded and replaced with a new component. The time required to service or replace the reference VCO and the cost of the work involved are unsatisfactory burdens that have to be borne by the owner or user of the terminal in which the reference VCO is used.

### SUMMARY OF THE INVENTION

According to the present invention in a first aspect there is provided a RF transceiver as defined in claim 1 of the accompanying claims.

According to the present invention in a second aspect there is provided a method of operation as defined in claim 13 of the accompanying claims.

Further features of the invention are as defined in the accompanying dependent claims and in the embodiments of the invention to be described.

Embodiments of the present invention will now be described by way of example with reference to the accompanying drawings, in which:

### BRIEF DESCRIPTION OF THE DRAWINGS

FIG. 1 is a block schematic circuit diagram of a phase locked loop frequency synthesizer for use in a RF transceiver embodying the invention.

FIG. 2 is a block schematic diagram of a reference oscillator included in the frequency synthesizer shown in FIG. 1.

FIG. 3 is a RF transceiver embodying the invention and including the synthesizer of FIG. 1.

FIG. 4 is a flowchart of a method of operation embodying the invention.

### DESCRIPTION OF EMBODIMENTS OF THE INVENTION

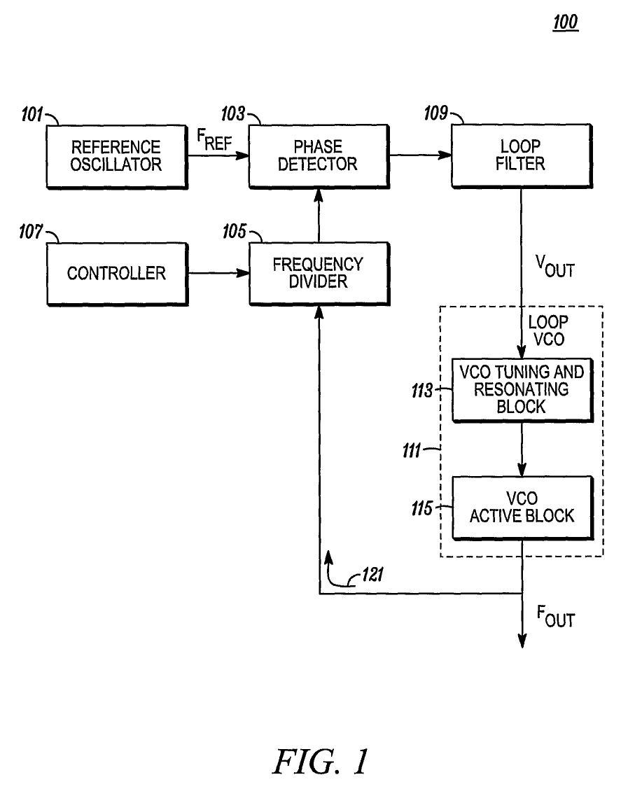

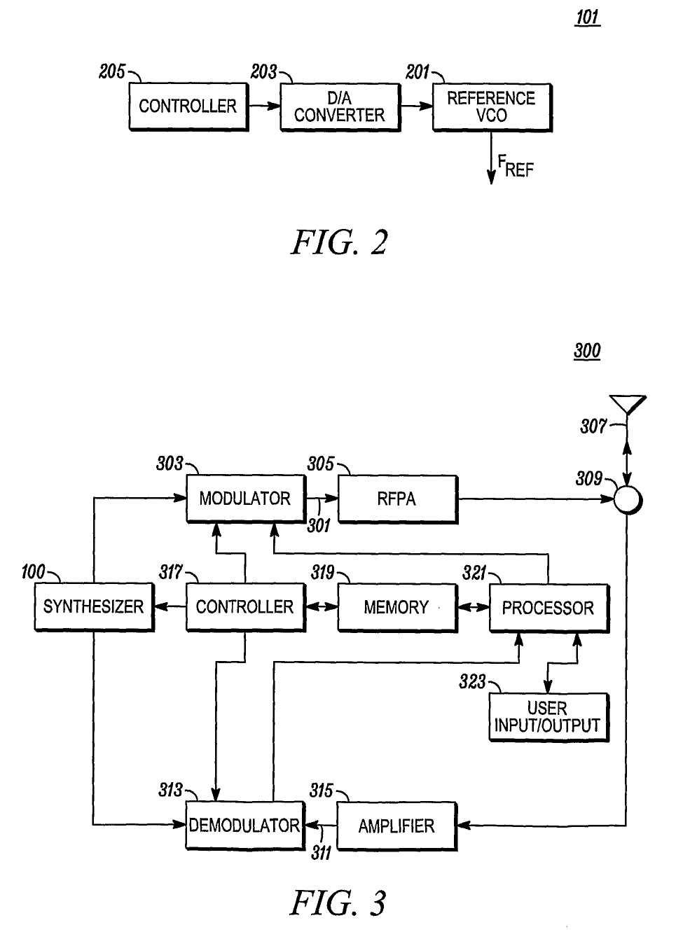

Reference is now made to FIG. 1, which is a block schematic circuit diagram of a phase locked loop (PLL) frequency synthesizer, generally referenced as 100, for use in an embodiment of the invention. The frequency synthesizer 100 includes a reference oscillator 101 to be described in more detail with reference to FIG. 2, a controller 107, a phase detector 103, a loop filter 109, a loop VCO 111 and a frequency divider 105. The loop VCO 111 includes as constituent parts a VCO tuning and resonating block or portion 113 and a VCO active block or portion 115. The reference oscillator 101 is connected to the phase detector 103. The frequency divider 105 is connected to the phase detector 103, the controller 107 and the VCO active block 115. The loop filter 109 is connected to the phase detector 103 and to the VCO tuning and resonating block 113. The VCO active block 115 is connected to the VCO tuning and resonating block 113 and to the divider 105. The loop including the loop VCO 111, the divider 105, the phase detector 103 and the loop filter 109 forms a phase locked loop 121.

The reference oscillator 101 provides a reference signal of frequency F_{REF} to the phase detector 103. The frequency divider 105 receives a feedback signal, having a frequency F_{OUT}, as an output from the VCO active block 115. The frequency divider 105 divides the frequency of this signal by a divisor number M and provides a resultant signal, having the frequency F_{OUT}/M, to the phase detector 103. The phase detector 103 compares the relative phase of the two resultant signals it receives, respectively from the reference oscillator 101 and the frequency divider 105, and generates an output control signal in response. The phase detector 103 includes an amplifier which amplifies the signal provided as an output control signal. The phase detector 103 provides its output control signal to the loop filter 109. Typically, the loop filter 109 is a low pass filter. The loop filter 109 integrates the output control signal and provides a resultant output voltage V_{OUT} to the VCO tuning and resonating block 113. The value of V_{OUT} is related to the values of M and the frequency of the reference signal F_{REF} provided by the reference oscillator 101. Depending on the value of the voltage V_{OUT} it receives, the VCO tuning and resonating block 113 adjusts an output frequency F_{OUT} of a signal it produces such that it is equal to a desired value. The VCO active block 115 amplifies the signal from the VCO tuning and resonating block 113 and provides the amplified signal as an output signal having a frequency F_{OUT}.

The controller 107 provides control of the value of V_{OUT} by controlling the value of the divisor number M. In one form of the frequency divider 105, the divider 105 may be a switched divider. In this form, the value of M may be varied between two possible values by rapid switching by the controller 107, according to a pre-defined switching program, between a first integer N and a second integer, e.g. N+1. This has the effect of providing an average value of M equal to a value between N and the second integer. In the case where the switching is between successive integers N and N+1, the divider 105 is known in the art as a ‘fractional-N’ divider.

The controller 107 which controls the loop 121 by controlling a parameter of the loop 121, namely the divisor number M applied by the frequency divider 105, may be provided in the form of a programmed digital signal processor. In one embodiment, the synthesizer 100 is employed in a RF transceiver to be described and the controller 107 may perform other control and signal processing functions of the transceiver.

In alternative forms of the synthesizer 100 (not shown) one or more components of the phase locked loop 121 may be replaced by one or more known components of equivalent function as will be readily apparent to those skilled in the art. Thus, for example, the phase detector 103 may be replaced by a phase frequency detector and the loop filter 109 may be replaced by an up/down counter and a D/A (digital to analog) converter. A phase frequency detector detects differences in frequency as well as in phase between the input signals from the reference oscillator 101 and the frequency divider 105 and produces a digital output signal comprising a series of up or down pulses whose pulse lengths are proportional to the measured phase difference. An algebraic sum of the pulses is found by the up/down counter. The up/down counter can be considered a digital equivalent of the loop filter 109. The D/A converter produces an output analog control signal which controls the loop VCO 111 in the same way as the voltage V_{OUT} produced by the loop filter 109 in FIG. 1.

FIG. 2 shows in more detail the reference oscillator 101 of the synthesizer 100. The reference oscillator 101 includes a reference VCO 201. The reference VCO 201 may be crystal oscillator, e.g. a TCXO as referred to earlier, or other known form of oscillator providing a precisely defined output reference frequency F_{REF} which is determined by the precise value of an analog control voltage applied to the reference VCO 201. A D/A (digital to analog) converter 203 provides a voltage source which produces the analog control voltage and applies it to the reference VCO 201. A controller 205 provides a digital control signal to the D/A converter 203 to indicate the value of the analog voltage to be applied by the D/A converter to the reference VCO 201. The controller 205, which may be a programmed digital signal processor, may be combined with the controller 107 shown in FIG. 1 in a single processing device (e.g. a single microprocessor chip).

FIG. 3 is a block schematic diagram of a RF transceiver 300 for use in a terminal operating for example in a cellular or trunked communication network, i.e. a network which provides RF communications to and from the terminal using an infrastructure such as including one or more base stations one of which provides a communication service to the terminal; additionally or alternatively the terminal including the transceiver 300 may be used in direct mode RF communications with other terminals without involvement of any infrastructure. The transceiver 300 may for example be incorporated in a mobile wireless terminal such as a vehicle carried or portable radio or a mobile telephone. The transceiver 300 includes the frequency synthesizer 100 described with reference to FIG. 1 connected to a modulator 303 and a demodulator 313. The modulator 303 is in a transmitter channel 301 and is connected to a RFPA (radio frequency power amplifier) 305. The RFPA 305 is connected to an antenna 307 via an isolator 309 such as a switch, circulator or the like which isolates the transmitter channel 301 from a receiver channel 311 when the transceiver 300 is in a transmission mode, i.e. transmission of a RF signal is taking place via the transmitter channel 301 and the antenna 307. The isolator 309 also isolates the receiver channel 311 from the transmitter channel 301 when the transceiver 300 is in a reception mode, i.e. receipt of a RF signal is taking place via the antenna 307 and the receiver channel 311.

The receiver channel 311 includes an amplifier 315, e.g. a low noise RF amplifier, connected to the demodulator 313.

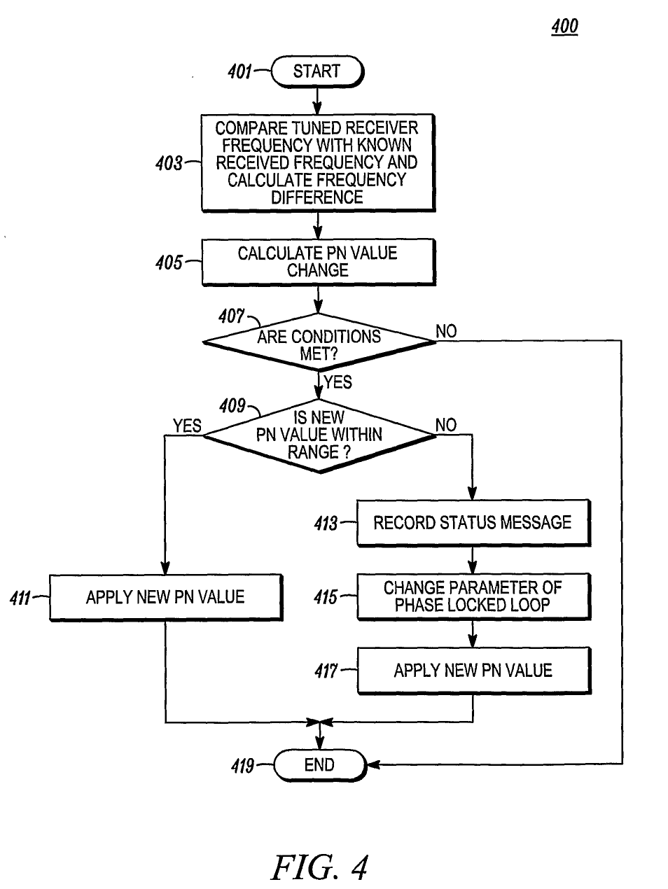

A controller 317 controls functions of the transceiver 300, particularly transmission and reception of RF signals. The controller 317 is connected to the modulator 303 to selectively activate a transmission mode of the transceiver 300 and to the demodulator 313 to selectively activate a reception mode of the transceiver 300. The controller 317 is also connected to the frequency synthesizer 100 for functions described in more detail with reference to FIG. 4.

When the transceiver 300 is in its transmission mode operation, takes place as follows. User information such as speech or data signals to be included in a transmitted signal are provided as an input signal at a user input/output 323, e.g. which includes input and output transducers such as a microphone and a speaker or a data input terminal and a data output terminal. The user information is processed into a digital form by a processor 321. The processor 321 applies the information in digital form suitable for inclusion in a RF signal. The frequency synthesizer 100 generates a RF carrier signal and applies the carrier signal to the modulator 303. The modulator 303 modulates the carrier signal with the information in digital form provided by the processor 321 to form an output signal which is a modulated RF signal. The RFPA 305 amplifies the modulated RF signal to produce an amplified, modulated RF signal and delivers the amplified, modulated RF signal to the antenna 307 via the isolator 309. The antenna 307 sends the signal over the air to a receiver at a remote terminal (not shown), for example a base station of a cellular or trunked system in which the terminal including the transceiver 100 is operating or directly to the receiver of another remote terminal such as repeater or a mobile or portable subscriber terminal.

When the transceiver 300 is in its reception mode operation takes place as follows. The antenna 307 receives an incoming RF signal sent over the air from a serving base station or another terminal operating in the cellular or trunked system such as a repeater or another fixed or mobile terminal of the system or a terminal having a direct mode operational link with the transceiver 300. The incoming RF signal is delivered via the isolator 309 to the receiver channel 311. The signal is amplified by the amplifier 315 and is passed to the demodulator 313 for processing to demodulate the signal. The demodulator 313 receives a reference local oscillator signal from the frequency synthesizer 100 to provide its demodulation function. The demodulator 313 extracts from the signal that it demodulates a digital signal representing communicated information. The demodulator 313 passes the digital signal to the processor 321 which processes the signal into a form suitable for delivery to the user input/output 323 where it is provided in suitable output form to a user.

The transceiver 300 includes a memory 319 connected to the controller 301 and to the processor 321 and also, via the controller 317, to the frequency synthesizer 100. The memory 319 stores data and programs needed in use by components of the transceiver 300, especially the controller 317, the processor 321 and the frequency synthesizer 100. The memory 319 may be of a form known in the art as a codeplug.

Thus, the transceiver 300 includes a transmitter portion which includes the transmitter channel 301, including the modulator 303 and the RFPA 305, together with the controller 317, the memory 319 and the processor 321. Similarly, the transceiver 300 includes a receiver portion which includes the receiver channel 311, including the demodulator 313 and the amplifier 315, together with the controller 317, the memory 319 and the processor 321.

The controller 317, which may be a programmed digital signal processor, may be combined with the processor 321 and/or the controller 107 (FIG. 1) and/or the controller 205 (FIG. 2) and/or the memory 319 in a single processing device (e.g. a single microprocessor chip).

FIG. 4 is a flowchart showing a method 400 of operation embodying the invention. The method 400 is an algorithm which is operated by the controller 205 (FIG. 2) in conjunction with the controller 317 and the memory 319 (FIG. 3). The method 400 is operated when the transceiver 300 has established a valid RF communication link with a remote RF transceiver having a precisely known frequency. The remote RF transceiver is preferably a transceiver of a serving or other base station in a cellular or trunked communication system (network) but it could alternatively be any other RF transceiver having a precisely known transmission frequency, such as a repeater or other remote mobile or fixed transceiver that operates in the cellular or trunked system or in a direct mode link with the transceiver 300. This is preferably a serving base station. Thus, the controller 205 is operable to apply the algorithm represented by the method 400, and/or a control signal to the D/A converter 203 to provide a change to the control voltage provided by the D/A converter 203, only when the transceiver 300 has an RF link with a remote RF transceiver which is preferably a serving base station. The communication system may for example be a TETRA system, i.e. a system operating in accordance with the TETRA standard defined by ETSI (European Telecommunication Standards Institute), although use in a TETRA system is illustrative rather than limiting.

In the method 400 to be described, reference is made to a ‘PN value’. This is the value of a digital word applied by the controller 205 to the D/A converter 205 (FIG. 2) to set the level of the analog control voltage to be applied by the D/A converter 205 to the reference VCO 201. The digital word may for example be an 8 bit word having 128 possible values giving 128 possible incrementally different values of the analog control voltage.

The method 400 of FIG. 4 begins at a start step 401 which is initiated every time an AFC (automatic frequency control) algorithm operates in the receiver portion of the transceiver 300. Such an algorithm may for example be initiated every 4 seconds (4 multiframes in a TETRA timing structure). In a step 403, the tuned receiver frequency currently used by the receiver portion of the transceiver 300, as determined for example from the AFC algorithm of the receiver portion, is measured and is compared with the precisely known frequency of a received signal. The tuned receiver frequency is dependent on the local oscillator reference frequency provided by the synthesizer 100. The received signal of precisely known frequency may be from a base station or other known terminal of the communication system to which a link has been established. If, for example, the signal is received from a serving base station, the base station may be one that is synchronized to the GPS (Global Positioning System) by use of signals received from satellites of the GPS by a GPS receiver associated with the base station. Such a synchronization procedure is used in base stations of a TETRA system. The frequency of signals sent by the transceiver of the base station is thereby highly synchronised to the GPS. Typically such signals have a frequency error of not more than 0.1 ppm (part per million). In the step 403 any difference or error Δf between the tuned receiver frequency and the precisely known frequency of the received signal is calculated.

In a step 405 a value of a change in the PN value is calculated which is required to adjust the analog control voltage applied by the D/A converter 203 by an amount to eliminate the frequency error Δf calculated in step 403. The change in PN value (and analog control voltage) could be a change in a positive or negative sense as appropriate. In step 405 there may also be a mechanism to prevent the method 400 from proceeding beyond step 405 if the calculated PN value change is an unusually abnormal PN value change. In a decision step 407, a determination is made as to whether several pre-defined conditions are met to allow the change in PN value calculated in step 407 to be applied. These conditions may include:

(i) that the temperature of the transceiver 300 is within a given range, e.g. from +10 C to +40 C; the temperature may be monitored in a well known way for example by a thermistor connected to an analog to digital converter to digitize an output voltage from the thermistor representing temperature;

(ii) that the received signal strength (measured by the transceiver 300 in a known manner) of the received signal of precisely known frequency received by the receiver portion of the transceiver 300 is not less than a pre-determined threshold value, e.g. a strength not less than (better than or equal to) −100 dBm;

(iii) that the transceiver 300 is currently registered with an infrastructure of a cellular or trunked communication network in which the transceiver 300 is to operate.

(iv) that the PN value change is greater than a minimum defined step value.

Where it is determined in step 407 that not all of the required conditions are met (a ‘no’ result), the method 400 proceeds to an end step 419 where it ends. Where it is determined in step 407 that all of the conditions are met (a ‘yes’ result), the method 400 proceeds to a decision step 409 in which a determination is made to find out whether the PN value when changed as calculated in step 407 is within a pre-determined working range of valid PN values. Normally, the determination in step 409 will produce a ‘yes’ result. In this case, a step 411 is applied in which the change in PN value calculated in step 405 is included in a new PN value and is applied by the controller 205.

However, if the end of the pre-determined working range of valid PN values (and its corresponding analog control voltage) has already been reached as a result of previous successive changes made to the PN value and a further change would take the new PN value (and its corresponding analog control voltage) outside the working range, decision step 409 produces a ‘no’ result. When a ‘no’ result is produced in decision step 409 the method 400 proceeds to a step 413 in which a status message is initially recorded in the memory 319 to indicate that the ‘no’ determination has been made in step 409 and the method 400 has moved to steps 413 to 417. This is useful information in future servicing of the transceiver 300. After step 413, a step 415 is applied in which a signal is passed by the controller 205 to the controller 107. This signal causes the controller 107 to change a parameter of the phase locked loop 121. In particular, the controller 107 makes an incremental change to the value of the divisor number M used by the frequency divider 105 in the phase locked loop 121 (FIG. 1). The incremental change is a predetermined amount sufficient to adjust (e.g. make a one time incremental jump in) the required value of F_{REF} produced by the reference VCO 201 (FIG. 2) so that it is obtained by an in-range PN value, preferably a value which is in the middle of a predetermined working range of valid PN values.

The effect of the change in the divisor number M made in this way can be understood by the following brief analysis. The output frequency F_{OUT} produced by the loop VCO 111 is related to the reference frequency F_{REF} produced by the reference VCO 201 by the following relationship:

F_{OUT}=F_{REF}·M

where M is the divisor number referred to above and may be an integer or a number between two integers (as in a Fractional-N divider). In the transceiver 300, it is required to keep F_{OUT} constant since this determines the frequencies of the operational signals used in the transceiver 300 (i.e. the carrier frequency used by the transmitter portion and the local oscillator reference signal used by the receiver portion of the transceiver 300). Since an error can occur in F_{REF} as a result of the drift due to aging described above, changing M can be used to compensate for the error in F_{REF} thereby to keep F_{OUT} constant. Furthermore, the change can be used to return the required PN value (and corresponding analog control voltage) to obtain F_{REF} to the middle of its pre-determined working range.

In a step 417, applied together with step 415, a new PN value is applied by the controller 205. The new PN value is the value which has been re-set to the middle of the working range of PN values to give the required output frequency F_{OUT} from the synthesizer 100 when the divisor number M has been changed. Finally, in the step 419 which follows the step 417, the method 400 ends. It may be automatically restarted at step 401 after a pre-determined delay, e.g. 4 seconds.

The method 400 beneficially allows a correction required to the PN value used by the controller 205 to control the D/A converter 203 to be estimated and applied frequently to correct for drifts in the reference frequency F_{REF} caused by aging of the reference VCO 201. These corrections are beneficially carried out automatically and dynamically by the transceiver 300 itself without the need for the transceiver 300 to be returned to a service depot. Furthermore, where the transceiver 300 detects that the successive adjustments made to the PN value have caused the PN value (and the corresponding analog control voltage) to reach the end of a pre-determined working range (i.e. that a further change will take the PN value outside the working range) an automatic procedure can beneficially be applied in the transceiver 300 to make an automatic change to another parameter of the phase locked loop 121 of the synthesizer 100, e.g. the divisor number M by which the frequency divider 105 divides the frequency F_{OUT} of the output signal produced by the loop VCO 111, to adjust (e.g. make a one time incremental jump in) the required value of F_{REF} So that it is obtained by an in-range PN value, preferably a value which is in the middle of a predetermined working range of valid PN values.

1. A RF transceiver including a frequency synthesizer for generating a stable frequency operational signal, a reference VCO (voltage controlled oscillator) for providing a reference frequency for use in operation of the frequency synthesizer, a voltage source operably coupled to the reference VCO for producing a control voltage for controlling an output frequency of the reference VCO and a controller operably coupled to the voltage source for controlling the voltage applied by the voltage source, wherein the controller is operable to compare a value of a known frequency of a RF signal received by the transceiver with a value of a current operational receiver frequency of the transceiver to estimate an error of the current operational receiver frequency, and using the estimated error, to calculate a change needed to the control voltage to change the reference frequency to eliminate the estimated error and to determine whether the change needed will produce a control voltage which is within a pre-determined working range of control voltages and, if it is, to apply the calculated change to the control voltage and, if it is not, to issue a signal to change an operational parameter, other than the reference frequency, of the synthesizer, to keep the stable frequency signal produced by the frequency synthesizer at a required frequency.

2. A transceiver according to claim 1 wherein the known frequency is that of a RF signal received by the transceiver from a serving base station or another remote terminal of precisely known frequency.

3. A transceiver according to claim 1 wherein the frequency synthesizer comprises a phase locked loop including a loop VCO (voltage controlled oscillator), a frequency divider operable to receive an output signal produced by the loop VCO and a phase detector operable to receive input signals from the frequency divider and the reference VCO and to compare a phase of the input signals.

4. A transceiver according to claim 1 wherein the stable frequency operational signal produced by the frequency synthesizer at least one of:
is (i) a carrier signal for use by a transmitter portion of the transceiver; or
is (ii) a local oscillator reference signal for use by a receiver portion of the transceiver.

5. A transceiver according to claim 1 wherein the current operational receiver frequency of the transceiver is determined by the stable frequency operational signal produced by the frequency synthesizer.

6. A transceiver according to claim 1 wherein the voltage source comprises a digital to analog converter and the controller comprises a digital signal processor and is operable to apply a digital word to the digital to analog converter to control an analog output voltage produced by the digital to analog converter, the digital word being in a range of digital words corresponding to a working range of control voltages.

7. A transceiver according to claim 1 wherein the controller is operable to apply periodically an algorithm to determine a change needed to the control voltage.

8. A transceiver according to claim 7 wherein the controller is operable to apply at least one of the algorithm or a control signal to the voltage source to provide a change to the control voltage, only when the transceiver has a RF link with a serving base station.

9-10. (canceled)

11. A transceiver according to claim 1 wherein the controller is operable to issue a signal to change the operational parameter by an amount which requires application of a selected control voltage by the voltage source which is in the middle of the pre-determined working range and is operable to control the voltage source to change the control voltage to the selected control voltage.

12. A transceiver according to claim 1 wherein the synthesizer includes a phase locked loop including a loop VCO and a frequency divider operable to divide by a divisor number a frequency of an output signal produced by the loop VCO and wherein the signal issued by the controller is operable to produce a change in the divisor number.

13. A transceiver according to claim 12 wherein the frequency divider is a Fractional-N divider.

14. A method of operation in a RF transceiver which includes a frequency synthesizer for generating a stable frequency operational frequency signal, a reference VCO (voltage controlled oscillator) for providing a reference frequency for use in operation of the synthesizer, a voltage source operably coupled to the reference VCO for producing a control voltage for controlling an output frequency of the reference VCO and a controller operably coupled to the voltage source for controlling the voltage applied by the voltage source, the method including the controller comparing a value of a known frequency of a RF signal received by the transceiver with a value of a current operational receiver frequency of the transceiver to estimate an error of the current operational receiver frequency, using the estimated error to calculate a change needed to the control voltage to change the reference frequency to eliminate the estimated error and determining whether the change needed will produce a control voltage which is within a pre-determined working range of control voltages and, if it is, to apply the calculated change to the control voltage and, if it is not, issuing a signal to change an operational parameter, other than the reference frequency, of the synthesizer, to keep the stable frequency signal produced by the frequency synthesizer at a required frequency.

15. (canceled)

16. A method according to claim 14 wherein the synthesizer includes a phase locked loop including a loop VCO (voltage controlled oscillator) and a frequency divider operable to divide by a divisor number a frequency of an output signal produced by the loop VCO, and wherein the method includes a change being made to the divisor number.

17. A method according to claim 14 which includes the controller determining, prior to controlling the voltage source to apply the calculated change to the control voltage, whether one or more conditions are met.

18. A method according to claim 17 wherein the one or more conditions are selected from:
(i) a temperature of the transceiver being within a given range;
(ii) a received signal strength of the received signal being not less than a threshold value;
(iii) the transceiver being currently registered with an infrastructure of a cellular or trunked communication network in which the transceiver is to operate; and
(iv) a value of a calculated change being greater than a pre-defined minimum step value.

19. A transceiver according to claim 1 wherein the controller is operable to determine, prior to initiating a calculated change to the control voltage or to issuing a signal, that one or more operational conditions are satisfied, the conditions being selected from the following:
(i) that the temperature of the transceiver is within a given range;
(ii) that the received signal strength of the received signal of precisely known frequency is not less than a pre-determined threshold value;
(iii) that the transceiver is currently registered with an infrastructure of a cellular or trunked communication network; and
(iv) that the value of the required change is greater than a minimum defined step value.

20. A transceiver according to claim 6 wherein the controller is operable, when it issues a signal to change the operational parameter, also to apply a digital word in middle of the range of digital words, to re-set the control voltage.
